(19) United States
(12) Patent Application Publication
(10) Pub. No.: US 2010/0173527 A1
(43) Pub. Date: Jul. 8, 2010

(54) CARD SOCKET ASSEMBLY AND PORTABLE ELECTRONIC DEVICE USING SAME

(75) Inventor: RI ZHOU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/416,242

(22) Filed: Apr. 1, 2009

(30) Foreign Application Priority Data
Jan. 8, 2009 (CN) 200910300117.0

(51) Int. Cl. H01R 24/00; H04M 1/00

(52) U.S. Cl. 439/630; 455/550.1

(57) ABSTRACT

A card socket assembly includes a printed circuit board defining a cutout and a card socket mounted to the printed circuit board. The card socket is received in the cutout.

### BACKGROUND

1. Technical Field

The present disclosure relates to card socket assemblies and, particularly, to a card socket assembly used in a portable electronic device, e.g., mobile phone, personal digital assistant (PDA), palm computer and etc.

2. Description of Related Art

With the development of wireless technology, portable electronic devices are becoming smaller and multifunctional. A portable electronic device usually includes several data cards, e.g., a subscriber identity module (SIM) card used to store personal information and a secure digital memory (SD) card used to store audio data and video data. Thus, a multiuse card socket is required for these cards. Such type multiuse card socket can receive and read these cards simultaneously.

However, multiuse card sockets are bulky and increase the thickness of portable electronic devices once mounted on printed circuit boards.

Therefore, there is room for improvement within the art.

### BRIEF DESCRIPTION OF THE DRAWINGS

Many aspects of the card socket assembly can be better understood with reference to the following drawings. These drawings are not necessarily drawn to scale, the emphasis instead being placed upon clearly illustrating the principles of the present card socket assembly. Moreover, in the drawings like reference numerals designate corresponding sections throughout the several views.

FIG. 1 is an exploded, isometric view of a card socket assembly, in accordance with an exemplary embodiment.

FIG. 2 is similar to FIG. 1, but viewed from another aspect.

FIG. 3 is an assembled view of the card socket assembly shown in FIG. 2.

FIG. 4 is similar to FIG. 3, but viewed from another aspect.

FIG. 5 is an isometric view of a mobile phone incorporating the card socket assembly of FIG. 1.

### DETAILED DESCRIPTION

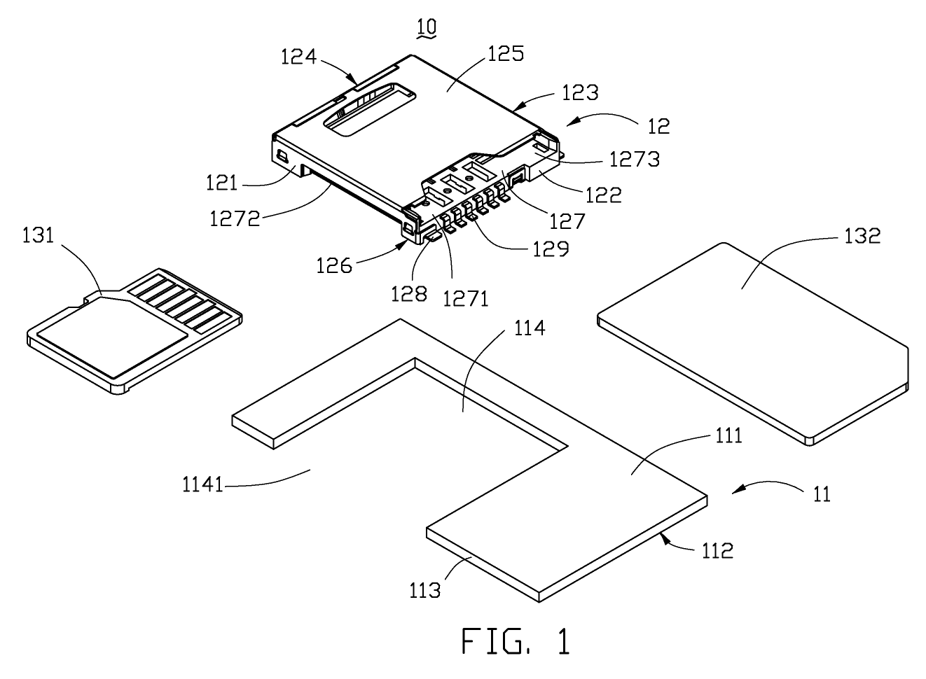

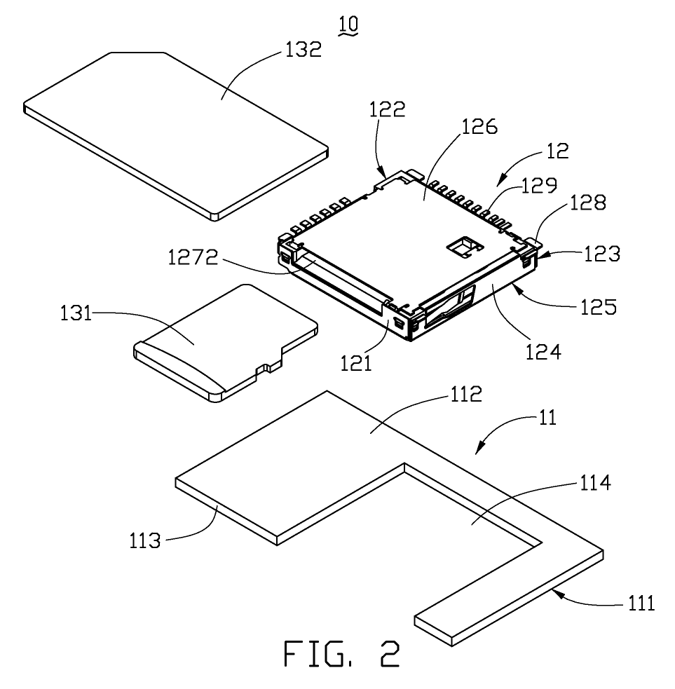

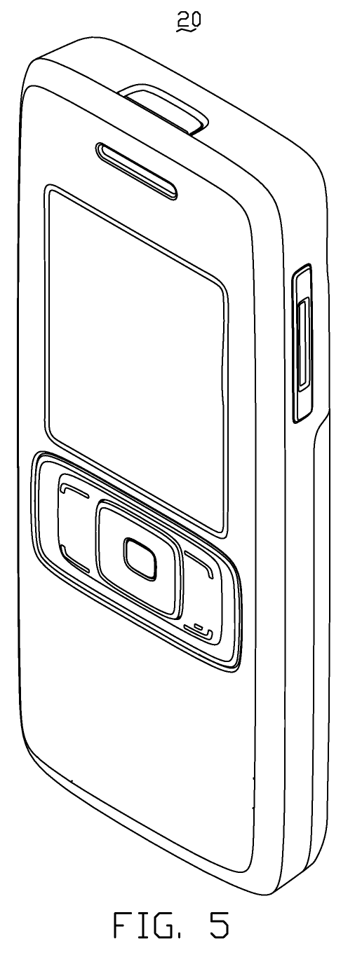

FIGS. 1 and 2 show an exemplary card socket assembly 10 used in portable electronic devices, such as mobile phone terminals, digital cameras, and others. In the exemplary embodiment, the card socket assembly 10 is mounted in a mobile phone 20 (shown in FIG. 5). The card socket assembly 10 includes a printed circuit board 11, and a multiuse card socket 12 mounted to the printed circuit board 11. The card socket 12 is configured for receiving a first data card 131 and a second data card 132 therein.

The printed circuit board 11 includes a working surface 111, a fastening surface 112 positioned opposite to the working surface 111, and a peripheral edge 113 connecting the working surface 111 and the fastening surface 112. The printed circuit board 11 defines a cutout 114 penetrating through the working surface 111 and the fastening surface 112, and forming an opening 1141 on the peripheral edge 113.

The multiuse card socket 12 is a hollow rectangular case, and includes four sidewalls, i.e., a first sidewall 121, a second sidewall 122, a third sidewall 123, a fourth sidewall 124, and two opposite surfaces, i.e., a top surface 125 and a bottom surface 126. The four sidewalls 121, 122, 123, 124 and the two surfaces 125, 126 cooperatively enclose a card receiving cavity 127 therebetween. The card socket 12 further includes a partition 1271, a plurality of fastening tabs 128, and a plurality of pins 129. The partition 1271 connects both with the four sidewalls 121, 122, 123, 124, thereby dividing the card receiving cavity 127 into two stacked sub-cavities, i.e., a first sub-cavity 1272, and a second sub-cavity 1273. The first sub-cavity 1272 is surrounded by the four sidewalls 121, 122, 123, 124, the partition 1271, and the top surface 125. The second sub-cavity 1273 is surrounded by the four sidewalls 121, 122, 123, 124, the partition 1271, and the bottom surface 126. The two sub-cavities 1272, 1273 both have a slot defined on a respective sidewall, e.g., the first sub-cavity 1272 has a slot defined on the first sidewall 121, and the second sub-cavity 1273 has a slot defined on the second sidewall 122. The fastening tabs 128 are disposed on the four side walls 121, 122, 123, 124, adjacent to the bottom surface 126. The fastening tabs 128 are fixed to the fastening surface 112 of the printed circuit board 11, thus mounting the multiuse card socket 12 to the printed circuit board 11. The pins 129 are in series, and are used to electrically connect the data cards 131, 132 to the printed circuit board 11.

The first data card may be a SIM card and the second data card may be an SD card. The first data card 131 can be inserted into the first sub-cavity 1272 using the slot on the first side wall 121. The second data card 132 can be inserted into the second sub-cavity 1273 using the slot on the second sidewall 122.

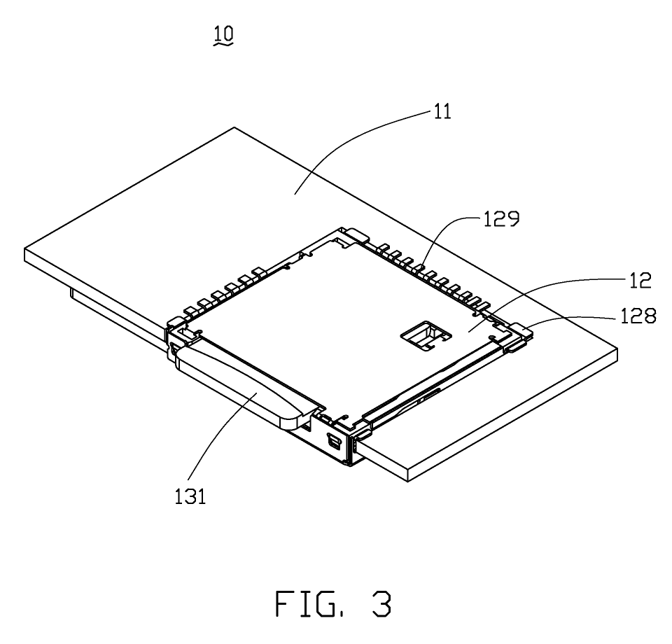

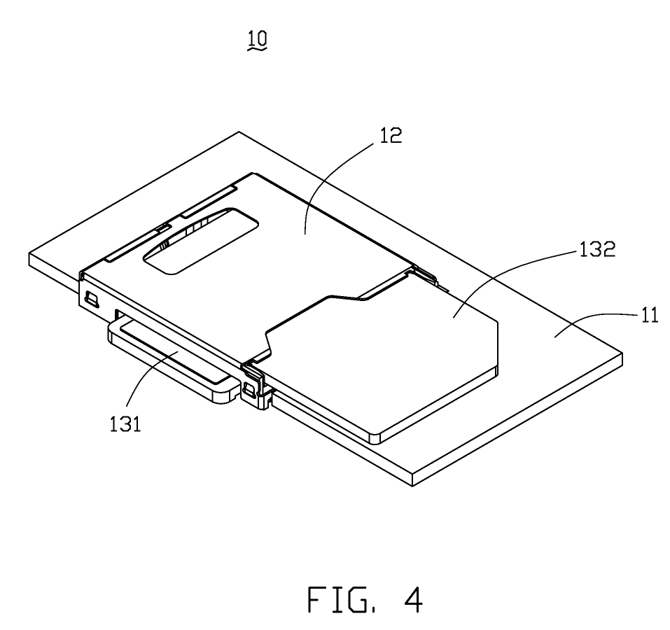

Referring to FIGS. 1, 2, 3 and 4 together, in assembly, the multiuse card socket 12 is inserted into the cutout 114, with the top surface 125 adjacent to the working surface 125 and the bottom surface 126 adjacent to the fastening surface 112. At this time, the first sub-cavity 1272 faces the opening 1141, the second sub-cavity 1273 is exposed from the working surface 111. The fastening tabs 128 are fixed on the fastening surface 112 by e.g., hot-melting or electric welding to mount the multiuse card socket 12 to the printed circuit board 11. Then the pins 129 are also respectively electrically connected to the fastening surface 112 of the printed circuit board 11 by e.g., hot-melting or electric welding.

Referring to FIG. 5, the multiuse card socket 12 is partially received in the cutout 114 of the printed circuit board 11, thus reducing the thickness of the card socket assembly 10. Therefore, the mobile phone 20 incorporating such card socket assembly 10 therein is thinner.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of sections within the principles of the disclosure to the full extent indicated by the broad general meaning of the terms, in which the appended claims are expressed.

1. A card socket assembly comprising:
a printed circuit board defining a cutout;
a card socket mounted to the printed circuit board and being received in the cutout, the card socket including a card receiving cavity, the card receiving cavity includes a first sub-cavity for accommodating a first data card therein and a second sub-cavity for accommodating a second data card therein;
wherein the first sub-cavity has a first opening facing in a first direction, the second sub-cavity has a second opening facing in a second direction perpendicular to the first direction.

2. The card socket assembly as claimed in claim 1, wherein the cutout forms an opening on a peripheral edge of the printed circuit board.

3. The card socket assembly as claimed in claim 2, wherein the printed circuit board includes a working surface connecting to the peripheral edge, the first sub-cavity facing the opening and the second sub-cavity exposing from the working surface.

4. The card socket assembly as claimed in claim 1, wherein a plurality of fastening tabs protrude from the card socket, the fastening tabs are fixed to the printed circuit board.

5. The card socket assembly as claimed in claim 1, wherein the cutout is defined through the printed circuit board.

6. A portable electronic device incorporating a card socket assembly, the card socket assembly comprising:
a printed circuit board defining a cutout; and
a card socket mounted to the printed circuit board and being received in the cutout, the card socket including a card receiving cavity;
wherein the card receiving cavity includes a first sub-cavity for accommodating a first data card therein and a second sub-cavity for accommodating a second data card therein, the first sub-cavity has a first opening facing in a first direction, the second sub-cavity has a second opening facing in a second direction perpendicular to the first direction.

7. The portable electronic device as claimed in claim 6, wherein the cutout forms an opening on a peripheral edge of the printed circuit board.

8. The portable electronic device as claimed in claim 7, wherein the printed circuit board includes a working surface connecting to the peripheral edge, the first sub-cavity facing the opening and the second sub-cavity exposing from the working surface.

9. The portable electronic device as claimed in claim 6, wherein a plurality of fastening tabs protrude from the card socket, the fastening tabs are fixed to the printed circuit board.

10. The portable electronic device as claimed in claim 6, wherein the cutout is defined through the printed circuit board.

11. A card socket assembly comprising:
a printed circuit board defining a cutout; and
a card socket mounted to the printed circuit board and being received in the cutout, the card socket includes a first sub-cavity for accommodating a first data card therein and a second sub-cavity for accommodating a second data card therein;
wherein the first sub-cavity is stacked perpendicularly with second sub-cavity.

12. The card socket assembly as claimed in claim 11, wherein the cutout forms an opening on a peripheral edge of the printed circuit board.

13. The card socket assembly as claimed in claim 12, wherein the printed circuit board includes a working surface connecting to the peripheral edge, the first sub-cavity facing the opening and the second sub-cavity exposing from the working surface.

14. The card socket assembly as claimed in claim 11, wherein a plurality of fastening tabs protrude from the card socket, the fastening tabs are fixed to the printed circuit board.

15. The card socket assembly as claimed in claim 11, wherein the cutout is defined through the printed circuit board.
